(19) United States
(12) Patent Application Publication
(10) Pub. No.: US 2017/0220219 A1
(43) Pub. Date: Aug. 3, 2017

(54) PRESENTATION CONTROL DEVICE

(71) Applicant: KYOCERA Corporation, Kyoto (JP)

(72) Inventors: Yuuya YAMAGUCHI, Yokohama-shi (JP); Takayuki FUJIKI, Tokyo (JP); Atsushi MIURA, Yokohama-shi (JP); Shunichi KISHIMOTO, Yokohama-shi (JP); Tsuneo MIYASHITA, Yokohama-shi (JP); Yoshiki MUROTANI, Yokohama-shi (JP); Yuta SAKAMOTO, Kawasaki-shi (JP)

(73) Assignee: KYOCERA Corporation, Kyoto (JP)

(21) Appl. No.: 15/420,354

(22) Filed: Jan. 31, 2017

(30) Foreign Application Priority Data
Feb. 3, 2016 (JP) 2016-019040

(51) Int. Cl. G06F 3/0485; G06F 3/033

(52) U.S. Cl. CPC G06F 3/0485; G06F 3/033

(57) ABSTRACT

A presentation control device includes a controller, which is including a processor coupled to a memory and configured, upon detection of an operation of moving a pointer presented on a display, to move the pointer in accordance with the operation as long as an end of a movable region of the pointer is not reached and scroll screens presented on the display in accordance with the operation at the end of the movable region of the pointer.

### TECHNICAL FIELD

The present disclosure relates to a presentation control device. In more detail, the present disclosure relates to a device that controls presentation on a display of, for example, a personal computer (PC).

### BACKGROUND

Terminals, such as desktop PCs or note PCs, sometimes present a variety of graphical user interfaces (GUIs) on displays to prompt a user to perform operations. For instance, presenting a pointer on the display allows a user to perform an operation of moving the position of the pointer by using an input device, such as a mouse or a touch pad (refer to, for example, Patent Literature 1). In another instance, presenting a scroll bar on the display allows a user to scroll screens by an operation of, for example, moving a knob of the scroll bar up and down, or to the left and the right, or clicking arrows at both ends of the scroll bar.

### CITATION LIST

### Patent Literature

Patent Literature 1: JP2009295147A

### SUMMARY

One of aspects of the present disclosure resides in a presentation control device, including:

a controller including a processor coupled to a memory and configured, upon detection of an operation of moving a pointer presented on a display, to

move the pointer in accordance with the operation as long as an end of a movable region of the pointer is not reached and

scroll screens presented on the display in accordance with the operation at the end of the movable region of the pointer.

### BRIEF DESCRIPTION OF THE DRAWINGS

In the accompanying drawings:

FIG. 1 is a block diagram illustrating a schematic structure of a presentation control device according to one of embodiments of the present disclosure;

FIG. 2 is a flowchart illustrating operation of a presentation control device according to the embodiment;

FIGS. 3A to 3D illustrate operation of a presentation control device according to the embodiment;

FIGS. 4A to 4C illustrate operation of a presentation control device according to the embodiment; and

FIGS. 5A to 5C illustrate examples of application of a presentation control device according to the embodiment.

### DETAILED DESCRIPTION

In a variety of terminals as described above, operability of the terminals is improved when the movement of the pointer and the scrolling of screens are achieved by easy and intuitive operation.

The present disclosure is to provide a presentation control device that improves operability.

A presentation control device according to one of embodiments of the present disclosure improves operability.

One of embodiments of the present disclosure will be described below with reference to the drawings.

The one of embodiments described below assumes a PC terminal, such as a desktop PC or a note PC. However, the embodiment is not limited to a terminal, such as a PC, and may be any electronic device, such as a tablet PC, a smartphone, a feature phone, and a game terminal, that presents a pointer on a display in use.

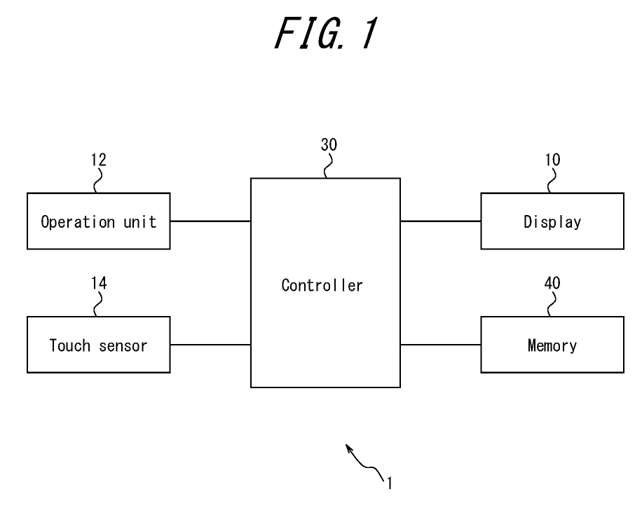

FIG. 1 is a block diagram illustrating a schematic structure of a presentation control device according to the one of embodiments of the present disclosure.

As illustrated in FIG. 1, a presentation control device 1 according to the present embodiment includes a display 10, an operation unit 12, a touch sensor 14, a controller 30, and a memory 40.

The display 10 may be any display device, such as a liquid crystal display, an organic EL display, or an inorganic EL display. To prompt a user who operates the presentation control device 1 to perform an operation, the display 10 presents objects, icon images, or the like that constitute a variety of GUIs, including a pointer. The display 10 may also present a variety of information, such as letters, symbols, and images.

The operation unit 12 may be any input device, such as keys (physical keys) like a keyboard, and a pointing device like a mouse or a trackball, that a user uses to perform an operation. When the operation unit 12 is composed of physical keys, each key may be configured by, for example, a self-return push button switch.

The touch sensor 14 detects contact made by a user and, if any, the position of the contact. As the touch sensor 14, a pointing device, such as a touch pad, may be adopted. The touch sensor 14 may also be superposed over a front surface of the display 10 (i.e., the display 10 and the touch sensor 14 may constitute a touch panel). In the above configuration, keys, such as ten keys, and icons may be presented as objects on the display 10, and an operation, performed by a user, of contacting any object may be detected by the touch sensor 14. The touch sensor 14 may be of any of various types, including a resistive film type, a capacitive type, and an optical type.

The controller 30 may be configured by a processor that controls and manages the entire presentation control device 1, including functional blocks included in the presentation control device 1. The controller 30 may be, for example, a CPU processor that executes a program describing a procedure of control. The program that the controller 30 executes may be stored in the memory 40, an external storage medium, or the like.

The memory 40 may be configured by a storage device, such as a semiconductor memory, and the memory 40 serves to store a variety of information, a program used to operate the presentation control device 1, and so forth and also serves as a work memory. The memory 40 may include a RAM, a ROM, or the like. The memory 40 may store a specific program corresponding to, for example, an application that causes the controller 30 to execute a specific function, and data pertaining to images of objects constituting the GUIs.

In the following, a description is given of operation of the presentation control device 1 according to the present embodiment.

In some GUI environments, the position of a pointer presented on a display may be shifted by using a pointing device, such as a mouse. Herein, the “pointer” refers to a small graphical image of an arrow or the like (e.g., an image of a mouse pointer operated by a mouse) that is presented to indicate an operation object in such a GUI environment. However, the pointer in the present embodiment is not limited to the aforementioned form and may be composed of any variety of images. In such an environment, when, for example, a user performs an operation of moving the mouse in the upward direction, the pointer presented on the display is also moved in the upward direction in accordance with the operation. The pointing device used to perform the operation is not limited to a mouse or the like and may also be, for example, a trackball or a touch pad.

In some cases, such a GUI environment also allows screens, presented on the display, to scroll at the time of, for example, presenting information that does not fit on a single screen of the display. For instance, when the aforementioned pointing device, such as a mouse, includes a scroll wheel, screens presented on the display may be scrolled by the scroll wheel. In such an environment, when, for example, a user performs an operation of rotating the scroll wheel in the downward direction, screens presented on the display are scrolled upward in accordance with the operation. Furthermore, some types of input device allow screens, presented on the display, to be scrolled to the left and the right in accordance with an operation of tilting the scroll wheel to the left and the right.

Moreover, when a scroll bar is presented on screens on the display, moving (dragging) a knob of the scroll bar or clicking arrows at both ends of the scroll bar sometimes allow the scrolling of screens presented on the display. In such an environment, when, for example, a user performs an operation of moving the knob of the scroll bar in the downward direction or clicking an arrow at a lower end of the scroll bar, screens presented on the display are scrolled upward in accordance with the operation. In some cases, the scroll bar is presented in the horizontal direction so that screens may be scrolled in the left and the right direction.

Thus, conventionally, an operation of, for example, moving the mouse is necessary to move the pointer, and an operation of the scroll wheel, the scroll bar, or the like is necessary to scroll screens. That is to say, different operations are conventionally required for moving the pointer and for scrolling screens. The present embodiment of the present disclosure therefore is to achieve both the movement of pointer and the scrolling of screens by a series of easy and intuitive operation. That is to say, the embodiment of the present disclosure permits the movement of pointer and the scrolling of screen simply by operation of moving the pointer.

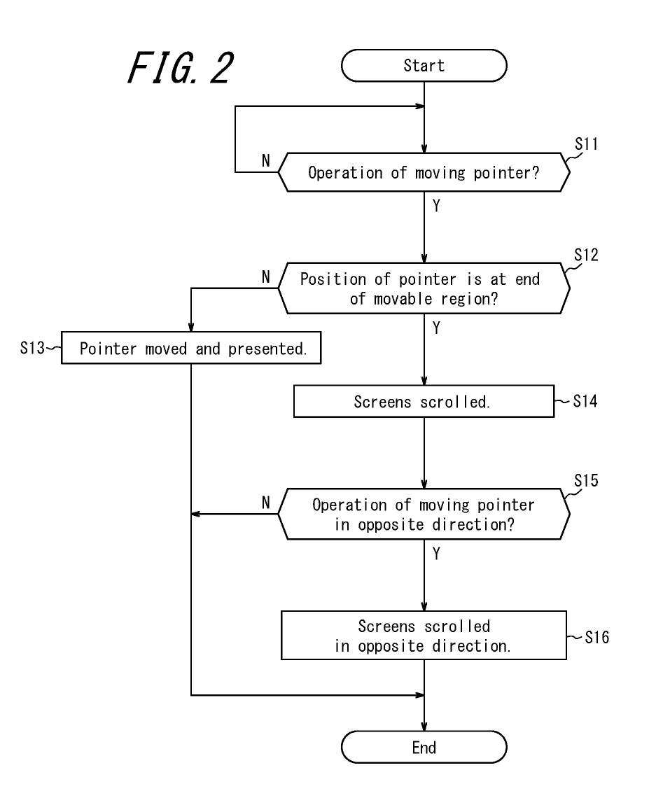

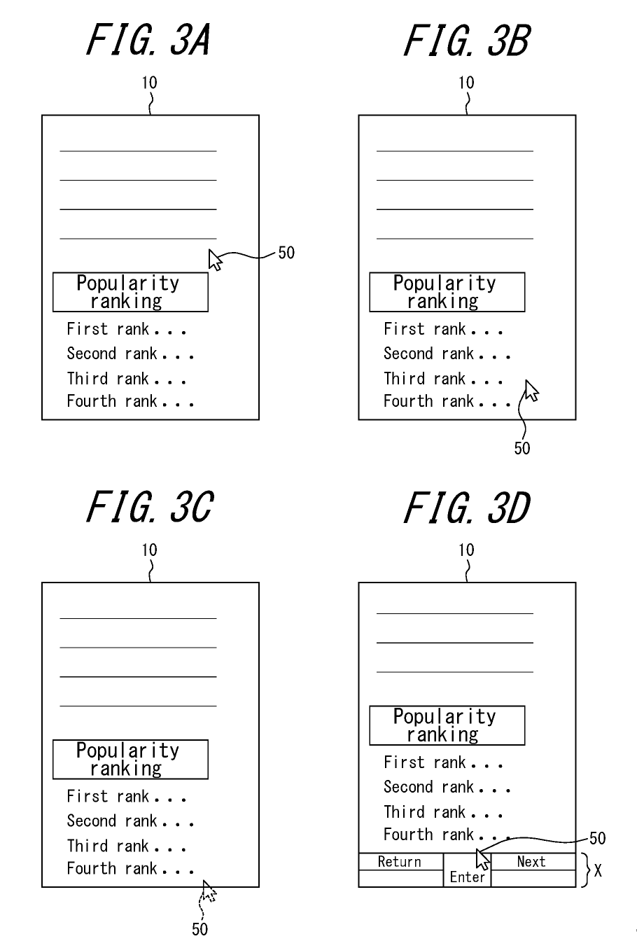

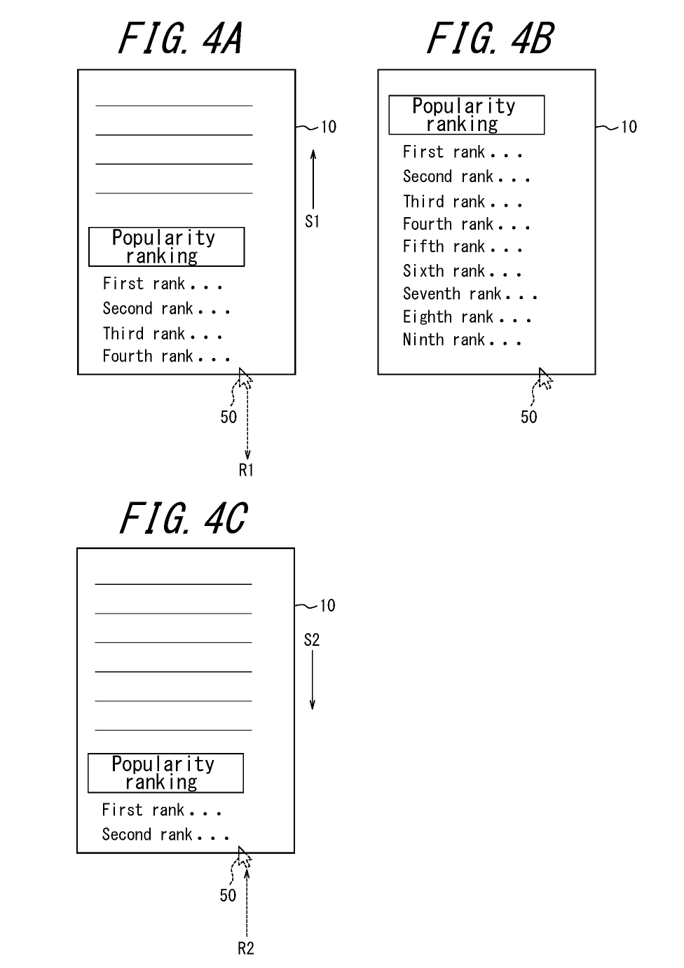

FIG. 2 is a flowchart illustrating operation of the presentation control device 1. FIGS. 3A to 3D and FIGS. 4A to 4C illustrate examples of screen presentation on the display 10 of the presentation control device 1.

Note that, when the operation illustrated in FIG. 2 is started, a pointing device, such as a mouse or a touch pad in the presentation control device 1 may detect an operation performed by a user. In the present embodiment, the pointing device, such as a mouse, may be adopted as the operation unit 12. Furthermore, in the present embodiment, a device, such as a touch pad or a touch panel, may be adopted as the touch sensor 14.

The following description assumes, as an example, that, when the operation illustrated in FIG. 2 is started, the controller 30 included in the presentation control device 1 presents an image illustrated in FIG. 3A on the display 10. FIG. 3A presumes, as an example, a scene in which some sort of popularity ranking is viewed on a website using an Internet browser. As illustrated in FIG. 3A, a pointer 50 is presented on a screen of the display 10.

When the operation illustrated in FIG. 2 is started, the controller 30 determines whether an operation of moving the pointer is performed (Step S11). That is to say, in Step S11, the controller 30 determines whether a user's operation is performed on the operation unit 12 or the touch sensor 14. For instance, when the operation unit 12 is a mouse, the controller 30 determines whether a user has performed an operation of moving the position of the mouse. In another instance, when the touch sensor 14 is a touch pad, the controller 30 determines whether a user has performed a (dragging or flicking) operation on the touch pad. When determining that an operation of moving the pointer is not performed in Step S11, the controller 30 repeats the operation of Step S11.

When determining that an operation of moving the pointer is performed in Step S11, the controller 30 determines whether the pointer 50, which is presented on the display 10, is positioned at an end of a movable region of the pointer (Step S12).

Herein, the movable region of the pointer refers to a region over which the pointer 50 is movable, and a typical example of the movable region of the pointer may be the entire screen of the display 10 illustrated in FIG. 3A. In the present embodiment, the pointer 50 cannot be presented on any position other than on the screen of the display 10. Accordingly, when the pointer 50 is positioned at the end of the movable region, the presentation control device 1 may present the pointer 50 still at the end of the movable region even if an operation of moving the pointer 50 further beyond the end is detected.

On the other hand, depending on presentation on the screen, as illustrated by a region X in FIG. 3D, there may be presented a region over which the pointer 50 cannot be operated for any instructions. In the region X illustrated in FIG. 3D, for example, the name of a function corresponding to a predetermined physical key, such as a function key, is presented, and the pointer 50 cannot instruct the item presented in the region X. In FIG. 3D, although a portion of the pointer 50 enters the region X, even when a user performs an operation of moving the pointer 50 further downward, a tip instruction portion of the pointer 50 cannot enter the region X. In this case, the movable region of the pointer is, as illustrated in FIG. 3D, the entire region, except for the region X, on the screen of the display 10.

When determining that the pointer 50 is not positioned at the end of the movable region in Step S12, the controller 30 controls the pointer 50 to be moved and presented on the display 10 in a direction corresponding to the detected operation (Step S13). After the pointer 50 is moved and presented in this way, the controller 30 preferably ends the operation illustrated in FIGS. 3A to 3D and starts the operation illustrated in FIGS. 3A to 3D again.

In FIG. 3A, the pointer 50 is positioned around the middle of the display 10 and is not positioned at the end of the movable region of the pointer. In this case, when a user performs an operation of moving the pointer 50 in the downward direction (Step S11), as illustrated in FIG. 3B, the pointer 50 is moved toward the lower side on the screen of the display 10 (Step S13). At this time, the controller 30 may change the amount of movement of the pointer 50, to be presented on the display 10, in accordance with the amount of movement of the operation of moving the pointer 50 within the movable region of the pointer 50. That is to say, the greater the amount of movement of the operation of moving the pointer 50 is, the greater the amount of movement of the pointer 50, to be presented on the display 10, may be. In the state illustrated in FIG. 4B, when a user performs an operation of moving the pointer 50 further in the downward direction (Step S11), as illustrated in FIG. 3C, the pointer 50 is moved further toward the lower side on the screen of the display 10 (Step S13).

Thus, in the present embodiment, upon detecting an operation of moving the pointer 50 presented on the display 10, the controller 30 may control the pointer 50 to be moved as long as the end of the movable region of the pointer 50 is not reached.

In the state illustrated in FIG. 3C, the pointer 50 is positioned at the end of the display 10, that is to say, at the end of the movable region of the pointer. In FIG. 3C, a portion of the pointer 50 is outside the movable region and is not presented on the display 10, and this portion is represented by a broken line. As illustrated in FIG. 3C, even when the portion of the pointer 50 is outside the movable region, the tip instruction portion of the pointer 50 is positioned at the end of the movable region of the pointer. In this case also, the pointer 50 is considered to be positioned at the end of the movable region of the pointer 50 in the present embodiment.

A description is given below of cases in which an operation, performed by a user, of moving the pointer 50 further beyond the end (i.e., in the downward direction, that is to say, in a direction from the inside of the outside of the movable region) is detected in the state where the pointer 50 is positioned at the end of the movable region as illustrated in FIG. 3C. Such a case corresponds to the situation where an operation, performed by a user, of moving the pointer is detected in Step S11 and where the pointer is positioned at the end of the movable region in Step S12.

When the pointer is positioned at the end of the movable region in Step S12, the controller 30 scrolls screens presented on the display 10 (Step S14). In Step S14, the controller 30 preferably scrolls screens presented on the display 10 in a direction opposite to the direction of movement of the pointer 50 detected in Step S11.

FIG. 4A illustrates the situation where an operation, performed by a user, of moving the pointer 50 further in the direction R1 in the state where the pointer 50 is positioned at the end of the movable region. In this case, the controller 30 scrolls screens presented on the display 10 in the direction S1. At this time, to notify that the pointer 50 is outside the movable region, the pointer 50 does not need to be presented on the display 10, or, the pointer 50 may be presented without any movement as illustrated in FIG. 4A.

Furthermore, when the operation, performed by a user, of moving the pointer 50 in the downward direction includes components in the left and the right direction, the pointer 50 may be moved only in the left and the right direction in correspondence with the components in the left and the right direction.

In the situation illustrated in FIG. 4A, when an operation, performed by a user, of moving the pointer 50 further in the direction R1 is detected, as illustrated in FIG. 4B, screens presented on the display 10 are scrolled. FIG. 4B represents that the number of items presented as the popularity ranking is increased since screens are scrolled in the upward direction (in the direction S1). At this time, the controller 30 may change the amount of scrolling of screens presented on the display 10 in accordance with the amount of movement of the operation of moving the pointer 50 at the end of the movable region of the pointer 50. That is to say, the greater the amount of movement of the operation of moving the pointer 50 is, the greater the amount of scrolling of screens presented on the display 10 may be.

Thus, in the present embodiment, the controller 30 is configured, upon detection of an operation of moving the pointer 50 presented on the display 10 in the state where the pointer 50 is positioned at the end of the movable region, to scroll screens presented on the display 10 in accordance with the operation. Furthermore, in the present embodiment, the controller 30 is preferably configured to scroll screens presented on the display 10 in a direction opposite to the direction of operation of moving the pointer 50 at the end of the movable region of the pointer 50. Moreover, the controller 30 may change the amount of scrolling of screens presented on the display 10 in accordance with the amount of movement of the operation at the end of the movable region of the pointer 50. Additionally, when the operation of moving the pointer 50 is not a slow operation of, for example, sliding the touch sensor 14 but a quick operation, such as a flick operation, the effect of scrolling screens may linger on even after the operation.

After screens are scrolled in Step S14, the controller 30 determines whether an operation of moving the pointer in a direction opposite to the previous operation is detected (Step S15). That is to say, in Step S15, the controller 30 determines whether there is detected an operation of moving the pointer in the direction opposite to the operation of moving the pointer 50 detected in Step S11. This operation refers to, when, for example, the operation of scrolling screens in Step S14 is an operation of moving the pointer 50 in the downward direction, an operation of moving the pointer 50 in the upward direction immediately after Step S14.

When not determining that an operation of moving the pointer in the opposite direction is detected in Step S15, the controller 30 ends the operation illustrated in FIG. 2. On the other hand, when determining that an operation of moving the pointer in the opposite direction is detected in Step S15, the controller 30 causes screens presented on the display 10 to be scrolled in a direction opposite to that of the scrolling in Step S14 (Step S16) and subsequently, ends the operation illustrated in FIG. 2.

As described earlier, an operation of moving the pointer 50 in the direction R1 illustrated in FIG. 4A invokes the scrolling of screens in the direction S1, thus causing the screen presentation illustrated in FIG. 4B. Immediately after that, upon detection of an operation of moving the pointer 50 in the direction opposite to the direction R1, screens are scrolled in the direction opposite to the direction S1 as illustrated in FIG. 4C. FIG. 4C illustrates the situation in which, upon detection of an operation of moving the pointer 50 in a direction R2, that is, the direction opposite to the direction R1, screens are scrolled in a direction S2, that is, the direction opposite to the direction S1.

In one form of the present embodiment, the scrolling in the opposite direction may be performed when time from the scrolling of screens in Step S14 to the detection of an operation in Step S15 is less than a predetermined short time period, such as 0.5 seconds. That is to say, the scrolling in the opposite direction may be performed only when an operation of moving the pointer 50 in the opposite direction is detected immediately after the scrolling of screens in Step S14, and the scrolling in the opposite direction is not performed when some time elapses after the scrolling of screens in Step S14.

In another form of the present embodiment where an operation of moving the pointer 50 is performed by the touch sensor 14, the scrolling in the opposite direction is performed when an operation is detected in Step S15 without release (from a contact to a non-contact state) being detected after the scrolling of screens in Step S14. That is to say, the scrolling in the opposite direction may be performed only when an operation of moving the pointer 50 in the opposite direction is detected without release being released after the scrolling of screens in Step S14. On the other hand, when an operation of moving the pointer 50 in the opposite direction is detected following the detection of release after the scrolling of screens in Step S14, the scrolling in the opposite direction is not performed.

Thus, in the present embodiment, the controller 30 may be configured, upon detection of an operation of moving the pointer 50 immediately after the scrolling of screens presented on the display 10, to scroll screens presented on the display 10 in the opposite direction. Furthermore, the scrolling in the opposite direction may be stopped once, for example, the operation of moving the pointer 50 is released. The scrolling in the opposite direction may also be stopped once a different operation than the operation of moving the pointer 50 in the opposite direction, such as an operation of moving the pointer 50 in a direction perpendicular to the direction, is detected.

As has been described, according to the embodiment of the present disclosure, both the movement of the pointer 50 and the scrolling of screens presented on the display 10 are achieved by a series of easy and intuitive operation. That is to say, the embodiment of the present disclosure permits the movement of the pointer 50 and the scrolling of screen presented on the display 10 simply by operation of moving the pointer 50. Accordingly, the presentation control device according to the embodiment of the present disclosure improves operability of a variety of terminals.

The above description describes cases where the pointer 50 is moved in the downward direction and where screens are scrolled in the upward direction and cases where the pointer 50 is moved in the upward direction immediately after the scrolling of screens in the upward direction and where screens are scrolled in the downward direction. Needless to say, the presentation control device 1 according to the present embodiment may cope with opposite operation. That is to say, the pointer 50 may also be moved in the upward direction to scroll screens in the downward direction, and the pointer 50 may also be moved in the downward direction immediately after the scrolling of screens in the downward direction to scroll screens in the upward direction. Furthermore, the presentation control device 1 according to the present embodiment may naturally control the above operation in any direction, such as in the left and the right direction, not limited to the upward and the downward direction.

Although the present invention has been described based on the drawings and the embodiment, it is to be noted that a person skilled in the art may easily make various changes and modifications according to the present disclosure. Such changes and modifications are therefore to be understood as included within the scope of the present disclosure. For example, functions and the like included in various functional units, means, and steps may be rearranged as long as the functions and the like are logically consistent. A plurality of functional units, steps, and the like may also be integrated or separated. Furthermore, the above embodiment of the present disclosure does not necessarily need to be implemented exactly as described herein, and various features of the embodiment may be combined or partly omitted for implementation as needed.

For example, in FIG. 1, the presentation control device 1 according to the embodiment of the present disclosure is described to include the display 10. However, in cases where the presentation control device 1 according to the embodiment of the present disclosure is applied to, for example, a desktop PC, an external display is often provided in addition to a main body of the desktop PC. In such a case, the display 10 may be omitted in the presentation control device 1 according to the embodiment of the present disclosure.

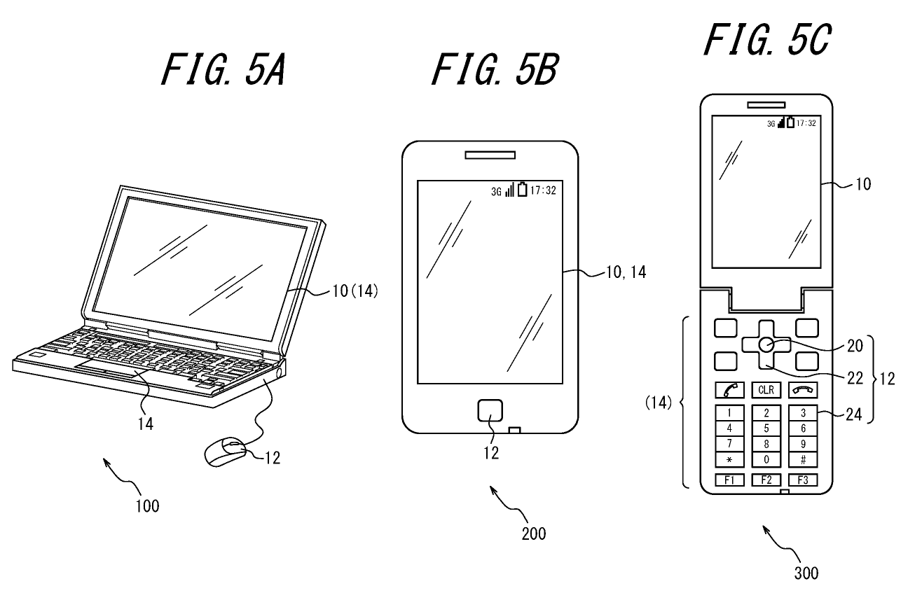

Furthermore, the presentation control device 1 according to the above embodiment of the present disclosure is described under the assumption that the presentation control device 1 is applied to a terminal, such as a note PC 100 as illustrated in FIG. 5A and a desktop PC. In this case, the pointer 50 may be moved in accordance with, for example, an operation of dragging the pointer 50 by using a mouse as the operation unit 12 or an operation of sliding the pointer 50 by using a touch pad as the touch sensor 14. Furthermore, when the display 10 of the note PC 100 illustrated in FIG. 5A is a touch panel 10 (14), which includes the touch sensor 14, the pointer 50 may be moved in accordance with an operation of sliding the pointer 50 by using the touch panel.

On the other hand, as described earlier, the presentation control device 1 according to the embodiment of the present disclosure is not limited to a terminal, such as a PC. For example, the presentation control device 1 according to the embodiment of the present disclosure may be applied to a terminal like a smartphone 200 illustrated in FIG. 5B. In this case, when the display 10 of the smartphone 200 is the touch panel 10 (14), which includes the touch sensor 14, the pointer 50 may be moved in accordance with an operation of sliding the pointer 50 by using the touch panel. Furthermore, the presentation control device 1 according to the embodiment of the present disclosure may be applied to a terminal like a feature phone 300 illustrated in FIG. 5C. In this case, in accordance with an operation of pressing a direction key (cursor key) 22, a ten key (dial key) 24, or the like, which constitutes the operation unit 12 of the feature phone 300, the pointer 50 may be moved in a direction corresponding to the pressed key.

A terminal like the feature phone 300 often does not include a touch sensor. However, as illustrated in FIG. 5C, at least a portion of an operation surface including various keys constituting the operation unit 12 of the feature phone 300 sometimes has the function of the touch sensor 14. In such a terminal, the operation surface in the keys and/or a housing excluding the keys is used as, for example, an electrostatic sensor, which is configured to detect an operation, such as touching or sliding, performed by a user. In the above configuration, in accordance with an operation, performed by a user, of sliding the pointer 50 on the touch sensor 14 illustrated in FIG. 5C, the pointer 50, which is presented on the display 10, may be moved, and/or, screens may be scrolled. For instance, the touch sensor 14 may detect a user's operation in any of a center key 20, a direction key (cursor key) 22, and a ten key (dial key) 24 (and a peripheral region thereof) among various keys constituting the operation unit 12. In another instance, the touch sensor 14 may detect a user's operation only in a center key 20 or a direction key (cursor key) 22 (and a peripheral region thereof) among various keys constituting the operation unit 12. In yet another instance, the touch sensor 14 may detect a user's operation only in a ten key (dial key) 24 (and a peripheral region thereof) among various keys constituting the operation unit 12. When the feature phone 300 is configured to detect a user's operation in a ten key 24 (and a peripheral region thereof), keys, such as numeric keys 1, 4, and 7, constituting the ten keys 24 illustrated in FIG. 5C may be disposed at a small distance from each other. By doing so, even when the keys 1, 4, and 7 do not include an electrostatic sensor or the like, such a sensor may be disposed between each key, and thus, a user's operation may be detected in the ten keys 24 (and a peripheral region thereof).

Additionally, the above embodiment of the present disclosure is described under the assumption that it is the pointer 50 that is presented and moved on the display 10. However, the embodiment of the present disclosure may use a variety of elements, such as a cursor instead of the pointer 50, that may be presented to indicate an operation object in a GUI environment.

1. A presentation control device, comprising:
a controller including a processor coupled to memory and configured, upon detection of an operation of moving a pointer presented on a display, to
move the pointer in accordance with the operation as long as an end of a movable region of the pointer is not reached and
scroll screens presented on the display in accordance with the operation at the end of the movable region of the pointer.

2. The presentation control device of claim 1, wherein
the controller changes the amount of the scrolling of screens presented on the display in accordance with the amount of movement of the operation at the end of the movable region of the pointer.

3. The presentation control device of claim 1, wherein
the controller is configured to scroll screens presented on the display in a direction opposite to a direction of the operation of moving the pointer at the end of the movable region of the pointer.

4. The presentation control device of claim 2, wherein
the controller is configured to scroll screens presented on the display in a direction opposite to a direction of the operation of moving the pointer at the end of the movable region of the pointer.

5. The presentation control device of claim 1, wherein,
after scrolling screens presented on the display in accordance with the operation, the controller is configured, upon detection of another operation in a direction opposite to a direction of the operation without the operation being released, to scroll screens presented on the display in an opposite direction.

6. The presentation control device of claim 2, wherein,
after scrolling screens presented on the display in accordance with the operation, the controller is configured, upon detection of another operation in a direction opposite to a direction of the operation without the operation being released, to scroll screens presented on the display in an opposite direction.

7. The presentation control device of claim 3, wherein,
after scrolling screens presented on the display in accordance with the operation, the controller is configured, upon detection of another operation in a direction opposite to a direction of the operation without the operation being released, to scroll screens presented on the display in an opposite direction.

8. The presentation control device of claim 4, wherein,
after scrolling screens presented on the display in accordance with the operation, the controller is configured, upon detection of another operation in a direction opposite to a direction of the operation without the operation being released, to scroll screens presented on the display in an opposite direction.
